(19) United States
(12) Patent Application Publication
(10) Pub. No.: US 2024/0303529 A1
(43) Pub. Date: Sep. 12, 2024

(54) MACHINE LEARNING-BASED APPLICATION MANAGEMENT FOR ENTERPRISE SYSTEMS

(71) Applicant: Accenture Global Solution Limited, Dublin 4 (IE)

(72) Inventors: Parag Rane, Thane West (IN); Prasanna Srinivasa Rao, Bengaluru (IN); Chinmaya Pani, Pune (IN); Brett Parenzan, Mount Pleasant, SC (US); Saurav Gupta, Kolkata (IN)

(21) Appl. No.: 18/118,124

(22) Filed: Mar. 6, 2023

(51) Int. Cl. G06N 20/00

(52) U.S. Cl. CPC G06N 20/00

(57) ABSTRACT

Aspects of the present disclosure provide systems, methods, and computer-readable storage media that support machine learning-based application management for enterprise systems. The aspects described herein enable resource and time-efficient scheduling of training anomaly detection models (e.g., machine learning (ML) models) corresponding to the applications based on log data generated by the applications. Aspects also provide integration of the trained anomaly detection models with an application dependency graph to enable prediction of application failures based on detected anomalies and relationships between applications determined from the application dependency graph. Further aspects leverage this integration to output reasons associated with predicted application failures and to provide recommended recovery actions to be performed to recover from the predicted application failures. Other aspects and features are also described.

### TECHNICAL FIELD

The present disclosure relates generally to machine learning-based and artificial intelligence-based application management for enterprise systems. Particular implementations leverage application log data to schedule training of anomaly detection models and machine learning models integrated with application dependency graphs to predict application failures and provide recommended actions to compensate for the failures.

### BACKGROUND

Enterprise systems continue to gain due to their ability to track and control many different aspects of an enterprise, operating as a “command center” for a user to monitor the status and health of the enterprise or its operations, generate reporting of various aspects of the enterprise, make decisions related to the enterprise, and other such activities. Although enterprise systems have improved enterprise management and control, there are also challenges associated with current enterprise systems. One challenge results in a cumbersome monitoring process due to the large number of microservices underlying the enterprise system, which may number in the hundreds or thousands. Monitoring such a large volume of applications, many of which interact with each other in undisclosed ways or are located in different units of the enterprise, can be time and resource intensive and can result in difficulties identifying an underlying cause of individual application failures. Some enterprise systems rely on manually maintained alert thresholds or other static, rule-based systems that are prone to false positive alerts. Additionally, support engineers that operate the enterprise systems are typically reactive to issues such as application failures, mainly identifying issues after they have occurred and performing post-event investigations instead of proactively preventing or compensating for the issues. Some enterprise systems have begun to integrate machine learning to detect failures in the system, but due to the large volume of underlying applications, configuring and training the machine learning to support an enterprise system can be time and cost prohibitive, often taking days to train the machine learning and significant processor and memory resources.

### SUMMARY

Aspects of the present disclosure provide systems, methods, and computer-readable storage media that support machine learning-based application management for enterprise systems. The aspects described herein enable resource and time-efficient training of anomaly detection models, integration of an application dependency graph with the anomaly detection models to predict application failures and provide reasoning for the predicted failures, and training of an application recovery model to provide recommended recovery actions for proactively dealing with detected and predicted application failures in enterprise systems. The techniques described herein support such application management functionality using log data generated by the applications and microservices that underlie the enterprise system without requiring changes to the code of the applications themselves.

To illustrate, a system described herein may include a server, or other computing device, that is configured to generate time-series data based on log data generated by multiple applications of an enterprise system. The times-series data may indicate performance of one or more key performance indicators (KPIs) over a time period, such as number of application failures, amount of application downtime, response times, resource usage, or the like. The server may perform clustering operations to assign each of the applications to at least one of multiple training groups based on the time-series data. In some implementations, temporal components such as trend components, seasonal components, and cyclic components, may be derived from the time-series data and used to determine the assignment of the applications to the training groups. After the clustering, the server may generate a training schedule that includes a sequence and frequency for training (or updating) of anomaly detection models (e.g., machine learning (ML) models) that correspond to the applications based on the training group to which the corresponding applications are assigned. For example, applications that correspond to anomaly detection models that are trained using the same preprocessing or post-processing operations or other KPIs may be sequenced to take advantage of performance of the same preprocessing or post-processing operations a single time or in a batch. Additionally or alternatively, anomaly detection models for applications that do not share dependencies may be scheduled to be trained concurrently to reduce training time of anomaly detection models for applications that are not interrelated. Scheduling the anomaly detection models for training may include generating an initial training sequence for all of the anomaly detection models, and then generating one or more additional training sequences for at least some of the anomaly detection models based on training or updating frequencies determined based on the training groups and the time-series data (or the temporal components).

In addition to managing training of the anomaly detection models, the system may generate an application dependency graph based on the time-series data, the log data, or a combination thereof. The application dependency graph represents relationships between the applications of enterprise system, particularly with respect to the KPIs. The server may integrate the application dependency graph by configuring and training a failure engine based on the application dependency graph to predict failures of applications based on detected anomalies output by the anomaly detection models. For example, in response to receiving a detected anomaly output by an anomaly detection model that corresponds to a first application, the failure engine may output predicted failures for a second application and a third application that are related to the first application in the application dependency graph. In some implementations, the failure engine may also be trained or configured to provide reasons for the predicted application failures, such as a textualization of the relationship between the first application and the second application, a relationship of a KPI associated with the detected anomaly and the second application or the third application, or the like. Additionally or alternatively, the server may train an application recovery model based on the output of the failure engine and historical recovery action data (e.g., from previously performed recovery actions) to train the application recovery model to generate one or more recommended recovery actions based on detected anomalies output by the anomaly detection models. For example, based on detection of an anomaly associated with the first application, the application recovery model may output recommendations to reboot the second application and to isolate the third application from any dependent applications, as a non-limiting example. In some implementations, the server may generate a dashboard or other graphical user interface (GUI) to display information to enable a user to manage the enterprise system, such as indications of detected and predicted application failures, reasoning for the predicted application failures, scores associated with the predicted application failures and/or the reasoning, recommended recovery actions, or a combination thereof. In some implementations, one or more recommended recovery actions may be automatically performed or initiated by the server.

Aspects of the present disclosure may provide one or more of the following benefits. Systems, devices, methods, and computer-readable media described herein support machine learning-based application management for enterprise systems. The techniques described herein provide for improved scheduling of training of ML models that results in faster training, thereby enabling more frequent updating and accordingly better adaptation to changes in application data over time. To illustrate, time-series data generated based on log data from applications may be used for clustering applications into various training groups, and scheduling of the training of corresponding anomaly detection models may be performed to take advantage of similarities in data processing between different training groups and sequencing of models from interdependent groups. For example, anomaly detection models from training groups that are associated with the same preprocessing and/or post-processing operations may be scheduled to be trained concurrently in order to perform the preprocessing and/or post-processing operations fewer times (e.g., together as a group), which may be more efficient than repeatedly performing the same preprocessing and post-processing operations with different anomaly detection models in a sequence. As another example, applications that are associated with one type of temporal components, such as seasonal components, trend components, or cyclic components, may be identified as being dependent on applications associated with other temporal components, and the training of the corresponding anomaly detection models may be scheduled in sequence for the most efficient use of time and computational resources during the training. This scheduling may result in faster and more resource-efficient training of anomaly detection models, in some implementations reducing a multi-day or multi-week training time to a multi-hour training time, thereby improving operation of an application management system that trains ML models to perform anomaly detection. Additionally or alternatively, aspects described herein may integrate an application dependency graph with the anomaly detection models as part of an overall application management system to predict application failures before they occur and provide reasoning and recommended recovery actions. To illustrate, by integrating the application dependency graph with the anomaly detection models, the system may predict application failures with an approximately 30-40% reduction in false positives compared to rule-based anomaly detection systems. The techniques described herein provide the improved training efficiency and reduction in false positives of failure prediction without requiring changes to the code of the underlying applications and microservices of the enterprise system, instead using application log data as a basis for operation. As such, the techniques provided herein provide scaling of a single application anomaly detection system to a multi-application, enterprise-level system based on a historical data reference (e.g., the log data) that operates faster, and therefore is able to be updated more frequently to adapt to changes in application performance, and with fewer false positives than rule-based systems. In some implementations, the techniques described herein also provide automatic generation of recommended recovery actions to recover, or mitigate or prevent, predicted application failures, thereby reducing downtime and associated costs to enterprise systems as compared to conventional systems that focus on reactive actions and post-event analysis for system performance.

In a particular aspect, a method for machine learning-based application management includes decomposing, by one or more processors, log data associated with a plurality of applications into time-series data representing values of one or more key performance indicators (KPIs) over a time period associated with the log data. The method also includes performing, by the one or more processors, clustering operations based on one or more temporal components derived from the time-series data to assign each of the plurality of applications to at least one of multiple training groups. The method includes determining, by the one or more processors, a training sequence for the plurality of applications based on the multiple training groups. The method further includes initiating, by the one or more processors, training of a plurality of anomaly detection models that correspond to the plurality of applications according to the training sequence. Each anomaly detection model of the plurality of anomaly detection models includes a machine learning (ML) model configured to detect occurrence of an anomaly by a corresponding application based on received application data.

In another particular aspect, a system for machine learning-based application management includes a memory and one or more processors communicatively coupled to the memory. The one or more processors are configured to decompose log data associated with a plurality of applications into time-series data representing values of one or more KPIs over a time period associated with the log data. The one or more processors are also configured to perform clustering operations based on one or more temporal components derived from the time-series data to assign each of the plurality of applications to at least one of multiple training groups. The one or more processors are configured to determine a training sequence for the plurality of applications based on the multiple training groups. The one or more processors are further configured to train a plurality of anomaly detection models that correspond to the plurality of applications according to the training sequence. Each anomaly detection model of the plurality of anomaly detection models includes a ML model configured to detect occurrence of an anomaly by a corresponding application based on received application data.

In another particular aspect, a non-transitory computer-readable storage medium stores instructions that, when executed by one or more processors, cause the one or more processors to perform operations for machine learning-based application management. The operations include decomposing log data associated with a plurality of applications into time-series data representing values of one or more KPIs over a time period associated with the log data. The operations also include performing clustering operations based on one or more temporal components derived from the time-series data to assign each of the plurality of applications to at least one of multiple training groups. The operations include determining a training sequence for the plurality of applications based on the multiple training groups. The operations further include initiating, by the one or more processors, training of a plurality of anomaly detection models that correspond to the plurality of applications according to the training sequence. Each anomaly detection model of the plurality of anomaly detection models includes a ML model configured to detect occurrence of an anomaly by a corresponding application based on received application data.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports machine learning-based application management according to one or more aspects;

FIG. 2 is a process flow diagram illustrating an example of a process for machine learning-based application management according to one or more aspects;

FIG. 3 is a process flow diagram illustrating an example of a process for scheduling training of anomaly detection models based on historical application data according to one or more aspects;

FIG. 4 is a process flow diagram illustrating an example of a process for training a plurality of anomaly detection models for enterprise system applications according to one or more aspects; and

FIG. 5 is a flow diagram illustrating an example of a method for machine learning-based application management according to one or more aspects.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, and computer-readable storage media that support machine learning-based application management for enterprise systems. The aspects described herein enable resource and time-efficient scheduling of training anomaly detection models corresponding to the applications based on log data generated by the applications. For example, time-series data may be generated from the log data, and the times-series data may indicate performance of one or more key performance indicators (KPIs) over a time period. Applications may be clustered based on the time-series data, such as based on temporal components derived from the time-series data, for assignment into multiple training groups. A training schedule may be generated that selects a sequence and frequency of training (or updating) of the anomaly detection models based on the training group to which the corresponding application is assigned. Aspects also provide integration of the trained anomaly detection models with an application dependency graph to enable prediction of application failures based on detected anomalies and relationships between applications determined from the application dependency graph. For example, based on detection of an anomaly with respect to a first application, predicted failures for one or more additional applications may be output based on the one or more additional applications being related to the first application in the application dependency graph. Further aspects leverage this integration to output reasons associated with predicted application failures and to provide recommended recovery actions to be performed to recover from the predicted application failures. For example, the reasoning for a predicted failure of an application may correspond to a relationship in the application dependency graph between the application and an application for which an anomaly is detected, the reasoning may be based on a KPI that relates the two applications in the application dependency graph, other information, or the like. To generate recommended recovery actions, a recovery model may be trained based on historical recovery actions performed for application failures and application failures of related applications (e.g., based on the application dependency graph). In some implementations, a dashboard or other graphical user interface (GUI) may be displayed to provide indication of detected and predicted application failures, reasoning for the predicted application failures, scores associated with the predicted application failures and/or the reasoning, recommended recovery actions, or a combination thereof, to enable a user to manage applications of an enterprise system and perform recovery operations to reduce or eliminate downtime associated with application failures. In some implementations, one or more recommended recovery actions may be automatically performed or initiated based on detection or prediction of application failures.

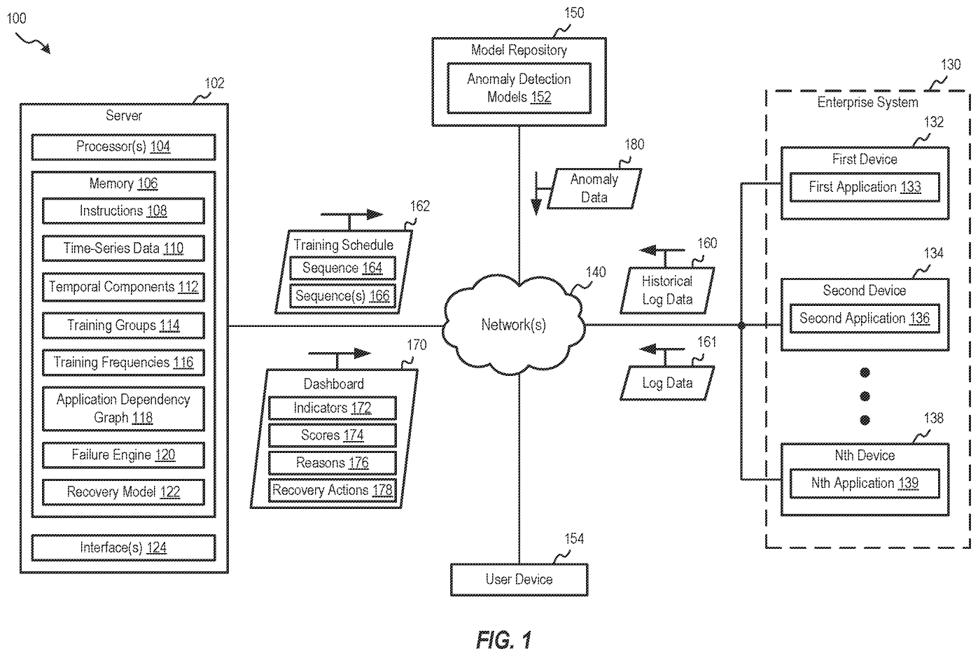

Referring to FIG. 1, an example of a system that supports machine learning-based application management according to one or more aspects of the present disclosure is shown as a system 100. The system 100 may be configured to schedule training of anomaly detection models with improved efficiency and to leverage machine learning and application dependency graphs to predict failures of enterprise system applications and to provide recommended actions to compensate for the predicted failures. As shown in FIG. 1, the system 100 includes a server 102, an enterprise system 130 that includes a first device 132, a second device 134, and an Nth device 138, a model repository 150, a user device 154, and one or more networks 140. In some implementations, the system 100 may include more or fewer components than are shown in FIG. 1, such as additional user devices, model repositories, or the like, or the model repository 150 and/or the user device 154 may be omitted (and the corresponding operations performed by the server 102), as non-limiting examples. Additionally or alternatively, the enterprise system 130 may include a different number of devices than shown in FIG. 1.

The server 102 may be configured to perform one or more operations herein to support machine learning-based application management. Although illustrated in FIG. 1 as a server, in some other implementations, the server 102 may be replaced with a desktop computing device, a laptop computing device, a personal computing device, a tablet computing device, a mobile device (e.g., a smart phone, a tablet, a personal digital assistant (PDA), a wearable device, and the like), a server, a virtual reality (VR) device, an augmented reality (AR) device, an extended reality (XR) device, a vehicle (or a component thereof), an entertainment system, other computing devices, or a combination thereof, as non-limiting examples. The server 102 includes one or more processors 104, a memory 106, and one or more communication interfaces 124.

It is noted that functionalities described with reference to the server 102 are provided for purposes of illustration, rather than by way of limitation and that the exemplary functionalities described herein may be provided via other types of computing resource deployments. For example, in some implementations, computing resources and functionality described in connection with the server 102 may be provided in a distributed system using multiple servers or other computing devices, or in a cloud-based system using computing resources and functionality provided by a cloud-based environment that is accessible over a network, such as the one of the one or more networks 140. To illustrate, one or more operations described herein with reference to the server 102 may be performed by one or more servers or a cloud-based system 142 that communicates with one or more client or user devices.

The one or more processors 104 may include one or more microcontrollers, application specific integrated circuits (ASICs), field programmable gate arrays (FPGAs), central processing units (CPUs) and/or graphics processing units (GPUs) having one or more processing cores, or other circuitry and logic configured to facilitate the operations of the server 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the server 102 may be stored in the memory 106 as instructions 108 that, when executed by the one or more processors 104, cause the one or more processors 104 to perform the operations described herein with respect to the server 102, as described in more detail below. Additionally, the memory 106 may be configured to store time-series data 110, temporal components 112, training groups 114, training frequencies 116, an application dependency graph 118, a failure engine 120, and a recovery model 122. Illustrative aspects of the time-series data 110, the temporal components 112, the training groups 114, the training frequencies 116, the application dependency graph 118, the failure engine 120, and the recovery model 122 are described in more detail below.

The one or more communication interfaces 124 may be configured to communicatively couple the server 102 to the one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the server 102 includes one or more input/output (I/O) devices (not shown in FIG. 1) that include one or more display devices, a keyboard, a stylus, one or more touchscreens, a mouse, a trackpad, a microphone, a camera, one or more speakers, haptic feedback devices, or other types of devices that enable a user to receive information from or provide information to the server 102. In some implementations, the server 102 is coupled to a display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the server 102. Alternatively, the server 102 may be configured to provide information to support display at one or more other devices, such as the user device 154, as a non-limiting example.

As briefly described above, the server 102 may be communicatively coupled to one or more other devices or systems via the one or more networks 140, such as the devices of the enterprise system 130, the model repository 150, and the user device 154. The enterprise system 130 may include or correspond to one or more devices, systems, components, or a combination thereof, that are configured to execute applications to support operations of an enterprise. As shown in FIG. 1, the enterprise system 130 may include the first device 132, the second device 134, and the Nth device 138. In other implementations, the enterprise system 130 may include fewer than three or more than three devices (e.g., N may be less than or greater than three). Each of the first device 132, the second device 134, and the Nth device 138 may include one or more processors, a memory, one or more I/O devices, and one or more communication interfaces, similar to as described with reference to the server 102. Additionally, the devices of the enterprise system 130 may be configured to execute one or more respective applications that operate to perform part of the overall functionality of the enterprise system 130. For example, the first device 132 may execute a first application 133, the second device 134 may execute a second application 136, and the Nth device 138 may execute an Nth application 139. In some implementations, one or more of the first application 133, the second application 136, and the Nth application 139 may be the same application. Alternatively, each of the first application 133, the second application 136, and the Nth application 139 may be different applications.

The model repository 150 may be configured to generate, train, execute, update, and/or store one or more machine learning (ML) models for use in performing one or more of the application management operations described herein. For example, the model repository 150 may manage anomaly detection models 152 that are configured to detect anomalies with corresponding applications (e.g., the first application 133, the second application 136, and the Nth application 139), as further described herein. The model repository 150 may include or correspond to one or more computing devices, one or more servers, one or more networked devices, one or more cloud storage or processing resources, one or more databases, other devices or systems, or a combination thereof. The anomaly detection models 152 may include or correspond to a plurality of ML models that are configured to perform anomaly detection for corresponding applications, as further described herein. The anomaly detection models 152 may be implemented by one or more ML or artificial intelligence (AI) models, which may include or correspond to one or more neural networks (NNs), such as multi-layer perceptron (MLP) networks, convolutional neural networks (CNNs), recurrent neural networks (RNNs), deep neural networks (DNNs), deep learning neural networks (DL networks), long short-term memory (LSTM) NNs, or the like. In other implementations, the anomaly detection models 152 may be implemented as one or more other types of ML models, such as support vector machines (SVMs), decision trees, random forests, regression models, Bayesian networks (BNs), dynamic Bayesian networks (DBNs), naive Bayes (NB) models, Gaussian processes, hidden Markov models (HMMs), regression models, or the like. Similarly, models described with reference to server 102 may also be implemented, in whole or in part, or may otherwise access, one or more ML models. To illustrate, the failure engine 120, the recovery model 122, or both, may include or correspond to one or more NNs, one or more SVMs, one or more decision trees, one or more random forests, one or more regression models, one or more BNs, one or more DBNs, one or more NB models, one or more Gaussian processes, one or more HMMs, one or more regression models, or the like. Although the model repository 150 is illustrated as a separate component from the server 102 in FIG. 1, in some other implementations, the server 102 may perform the operations of the model repository 150 (e.g., the server 102 may store and manage the anomaly detection models 152).

The user device 154 is configured to communicate with the server 102 via the one or more networks 140 to enable user interaction with the services provided by the server 102. For example, the user device 154 may display information related to management of applications of the enterprise system 130, such as indications of applications that are predicted to fail, reasons for the predicted failures, scores associated with the predicted failures or the reasons, recommended recovery actions, other information, or a combination thereof. The user device 154 may also communicate with the server 102 to enable user interaction, such as selection of a recovery action, interaction with a dashboard, or the like. The user device 154 may include or correspond to a computing device, such as a desktop computing device, a server, a laptop computing device, a personal computing device, a tablet computing device, a mobile device (e.g., a smart phone, a tablet, a PDA, a wearable device, and the like), a VR device, an AR device, an XR device, a vehicle (or component(s) thereof), an entertainment system, another computing device, or a combination thereof, as non-limiting examples. Although depicted as including a single user device 154, the system 100 is not so limited. For example, the system 100 may include a plurality of user devices 154 that enable multiple users to interact with the services provided by the server 102.

During operation of the system 100, the server 102 may receive historical log data 160 from the devices of the enterprise system 130. The historical log data 160 may indicate KPIs associated with the enterprise system 130, such as KPIs associated with one or more of the first application 133, the second application 136, or the Nth application 139, and application identifiers (IDs) of the corresponding application. The KPIs may include numbers of hits, success rates, failure rates, response times, downtimes, resource use, other performance indicators, or a combination thereof. The server 102 may generate the time-series data 110 based on the historical log data 160, such as by decomposing the historical log data 160 into a time-series representation. For example, the server 102 may extract data related to the KPIs from the historical log data 160 and aggregate the extracted data over various time periods to generate the time-series data 110.

In some implementations, the server 102 may derive or otherwise extract the temporal components 112 from the time-series data 110. The temporal components 112 may indicate temporal aspects of features of the time-series data 110 for the various applications. For example, the server 102 may decompose the time-series data 110 into one or more forms that represent one or more temporal components, and the decomposed data associated with each of the temporal components may be separated from the decomposed data associated with the other components for use in operations described further below. In some implementations, the temporal components 112 include trend components, seasonal components, cyclic components, or a combination thereof. Trend components may indicate trends (e.g., continual changes) in the time-series data 110 over time periods. Seasonal components may indicate portions of the time-series data 110 that correlate more strongly to one or more determined time periods (e.g., seasons) and less strongly to others. Cyclic components may indicate portions of the time-series data 110 that have identifiable patterns that repeatedly occur. These examples are illustrative, and in other implementations, the trend components, the seasonal components, the cyclic components, other components, or a combination thereof, may be selected to represent other temporal aspects extracted from the time-series data 110.

After generating the time-series data 110, the server 102 may perform one or more clustering operations on the temporal components 112 (or the time-series data 110) to assign corresponding applications to at least one of the training groups 114. To illustrate, the server 102 may assign segments of the time-series data 110 that correspond to different types of the temporal components 112 to different groups of the training groups 114, and this assignment results in assignment of the application (e.g., of the first application 133, the second application 136, and the Nth application 139) that corresponds to each segment to the same training group. As an example, two segments of the time-series data 110 may be clustered together based on the two segments having similar cyclic components, and the two applications that correspond to the two segments may therefore be assigned to a same training group of the training groups 114. As described above, the historical log data 160 may include application IDs, application names, or other information to identify the application that generated the log, and these application IDs may be used to maintain correspondence between segments of the time-series data 110 and the corresponding applications that generated the log data from which the segments were extracted. The training groups 114 may correspond to different KPI types, different KPI values, different temporal component types, different temporal component values or scores, other organization, or a combination thereof. For example, one training group may correspond to applications having a high cyclic component for number of hits, another training group may correspond to applications that have a decreasing trend component for success rate, and another training group may correspond applications that have a high seasonal component for a particular season for response times. These examples are illustrative, and the applications may be clustered based on many different types of KPIs, components, and the like, in order to improve the scheduling described herein.

After assigning the applications (via the corresponding time-series data 110 segments) to the training groups 114, the server 102 may determine a training schedule 162 for the anomaly detection models 152 based on the training groups 114 (e.g., based on the assignment of corresponding applications to the training groups 114). The training schedule 162 may include a sequence 164 (e.g., an initial training sequence) indicating a sequence or order in which the anomaly detection models 152 are to be initially trained. Each of the anomaly detection models 152 may be trained to detect occurrence of anomalies for a corresponding application based on portions of the historical log data 160 that are generated by the application, and the order of the training of the anomaly detection models 152 is indicated by the sequence 164. The server 102 may order the applications in the sequence 164 to take advantages of similarities and differences between temporal characteristics of application operation that may result in more efficient use of computer resources than a purely sequential or purely parallel training sequence. As an example, anomaly detection models for applications having similar cyclic components for some KPIs may be trained using similar preprocessing or post-processing operations, and as such, applications having similar cyclic components for a first KPI may be assigned to a first training group of the training groups 114 and applications having similar cyclic components for a second KPI may be assigned to a second training group of the training groups 114. In this example, the sequence 164 may indicate that one or more of the anomaly detection models 152 that correspond to applications in the first training group are to be trained concurrently with one or more of the anomaly detection models 152 that correspond to applications in the second training group. These anomaly detection models may be trained concurrently because one type of preprocessing or post-processing operations may be performed on portions of the historical log data 160 that correspond to applications in both training groups (e.g., first portions of the historical log data 160 that are used by anomaly detection models associated with applications in the first training group and second portions of the historical log data 160 that are used by anomaly detection models associated with applications in the second training group). Because a single set of preprocessing or post-processing operations is performed (as compared to two distinct sets), training these anomaly detection models concurrently reduces and overall training time for the anomaly detection models 152 and also utilizes less processing resources than concurrently training anomaly detection models that require different pre-processing or post processing operations. As another example, anomaly detection models for applications having different trend components for a same KPI may be trained using different preprocessing or post-processing operations, and as such, applications having trend components for a KPI that indicate a first trend may be assigned to a third training group of the training groups 114 and applications having trend components for the KPI that indicate a second trend may be assigned to a fourth training group of the training groups 114. In this example, the sequence 164 may indicate that one of the anomaly detection models 152 that corresponds to an application in the third training group is to be trained in series (e.g., sequentially) with one of the anomaly detection models 152 that corresponds to an application in the fourth training group. These anomaly detection models may be trained sequentially because they do not share preprocessing or post-processing operations, and therefore the increase in the overall training time for the anomaly detection models 152 may be offset by a larger increase in processing resources to concurrently train these anomaly detection models due to the performance of multiple processing operations concurrently.

The training schedule 162 may also include one or more additional training sequences (referred to herein as “sequences 166”) that indicate future training or updating sequences for at least some of the anomaly detection models 152. The sequences 166 may be generated based on the training frequencies 116. To illustrate, the server 102 may determine the training frequencies 116 based on the time-series data 110 (e.g., the temporal components 112), and based on the training frequencies 116, timing and sequencing of future training or updating for the anomaly detection models 152, or a portion thereof, may be scheduled. For example, a first group of anomaly detection models that correspond to applications having a highly cyclic component for a particular KPI may benefit from additional training (e.g., updating) according to a frequency of a corresponding cycle, while a second group of anomaly detection models that correspond to applications that are very active during a particular season (e.g., a repeating time period) may benefit from being updated frequently during the particular season but not during other seasons. In such an example, based on the training frequencies 116 representing this information, the sequences 166 may include scheduled training for the first group of anomaly detection models at time periods selected based on the frequency of the cycle and scheduled training for the second group of anomaly detection models that correspond to the particular season. Other examples of sequencing and scheduling are possible based on the time-series data 110, the temporal components 112, the training groups 114, and the training frequencies 116.

After determining the training schedule 162 (e.g., including the sequence 164 and optionally the sequences 166), the server 102 may transmit the training schedule 162 to the model repository 150 to initiate performance of the schedule training operations. For example, the model repository 150 may receive the training schedule 162 and perform training of the anomaly detection models 152 according to the training schedule 162. To further illustrate, initial training may be performed according to the sequence 164, and later training (e.g., updating) may be performed according to sequences 166. In some other implementations, the anomaly detection models 152 may be trained, and optionally stored, at the server 102, and the server 102 may perform the training according to the training schedule 162.

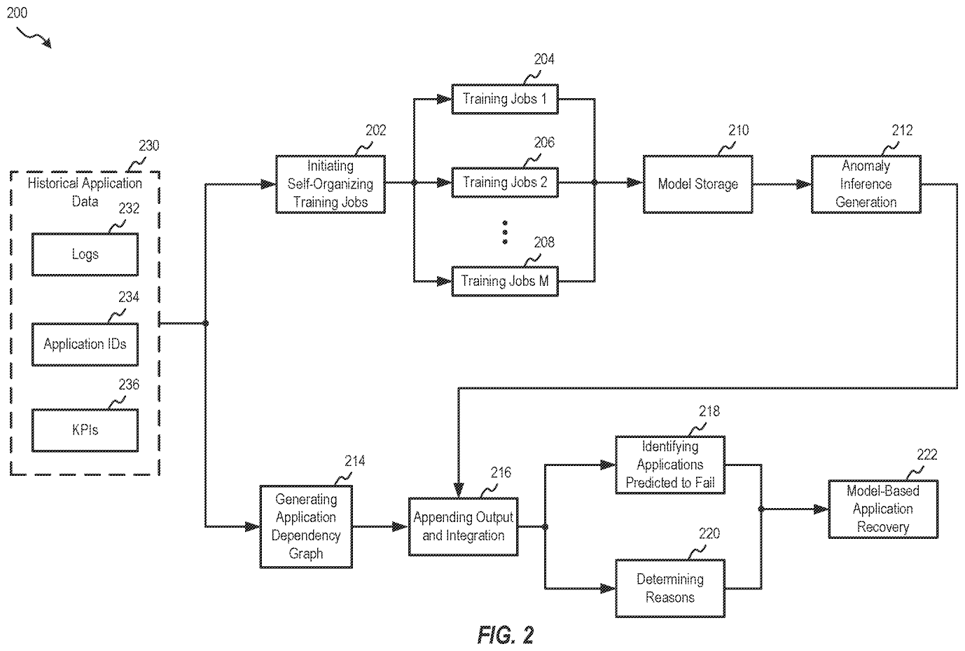

In addition to determining the training schedule 162, the server 102 may also generate the application dependency graph 118 based on the time-series data 110, the historical log data 160, or a combination thereof. The application dependency graph 118 may indicate dependencies between applications that underlie the enterprise system 130 (e.g., the first application 133, the second application 136, and the Nth application 139) with respect to the various KPIs. In some implementations, the application dependency graph 118 may include a plurality of nodes and edges between one or more pairs of nodes. Each node in the application dependency graph 118 may correspond to an application and each edge may correspond to a KPI. In such implementations, if a first node and a second node are linked by a first edge in the application dependency graph 118, this indicates that there is a dependency between a first application that corresponds to the first node and a second application that corresponds to the second node with respect to a KPI corresponding to the first edge (e.g., the first KPI depends on interaction between the first application and the second application). Additional details of application dependency graphs according to aspects of the present disclosure are described further herein with reference to FIG. 2.

The server 102 may train the failure engine 120 to output indicators 172 of applications that are predicted to fail based on input detected anomalies that are output by the anomaly detection models 152. To illustrate, the server 102 may train the failure engine 120 based on the application dependency graph 118 to output one or more predicted application failures (e.g., the indicators 172 of the applications predicted to fail) based on an input anomaly detected for an application by the anomaly detection models 152. The failure engine 120 may include, integrate, or execute a ML model configured to identify one or more additional applications that are predicted to fail based on detected anomalies output by the anomaly detection models 152. For example, failure engine 120 may be trained to output an indicator of the second application 136 based on receiving an anomaly associated with the first application 133 from the anomaly detection models 152 due to a relationship between the first application 133 and the second application 136 indicated by the application dependency graph 118 (e.g., that the second application 136 has a dependency on the first application 133 with respect to at least one KPI that is relevant to predicting failure of the second application 136). In this manner, the failure engine 120 may be configured to predict failures of applications for which anomalies are not detected by the anomaly detection models 152 and which are due to relationships between the applications indicated by the application dependency graph 118.

In some implementations, the server 102 may further train the failure engine 120 to output reasoning associated with the predicted application failures. To illustrate, the server 102 may train the failure engine 120 based on the application dependency graph 118 and text data derived from the application dependency graph 118 to configure the failure model to output reasons 176 that correspond to the indicators 172 of the predicted application failures. For example, if the second application 136 is predicted to fail based on receipt of an anomaly associated with the first application 133, the reasons 176 may include text that describes that the success rate of the second application 136 (e.g., a KPI) is dependent on the first application 133. This text may be derived from the existence of an edge corresponding to success rate that connects a node associated with the second application 136 to a node associated with the first application 133 in the application dependency graph 118. The text used to rain the failure engine 120 may be generated based on user input, based on performance of one or more natural language processing (NLP) operations on the application dependency graph 118, historical recovery and investigation data, other information, or a combination thereof.

In some such implementations, the failure engine 120 may also be configured to output failure scores 174 associated with the reasons 176, the indicators 172, or both. The failure scores 174 may represent confidence values that a corresponding predicted application failure is likely to occur, confidence values that a corresponding reason correctly explains a related application failure prediction, or both. Failure scores may be determined for predicted application failures or reasons for predicted application failures based on weight values associated with edges in the application dependency graph, based on simultaneous failure counts for applications derived from the historical log data 160, based on current KPI values monitored by the server 102, other information, or a combination thereof. For example, if the failure engine 120 predicts that the second application 136 will fail based on a detected anomaly associated with the first application 133 output by the anomaly detection models 152, the failure engine 120 may generate a corresponding failure score based a comparison of a current value of a KPI associated with the predicted application failure and a threshold (e.g., the failure score may be higher if the current value is greater than the threshold, and thus the second application 136 is more likely to continue operating despite the failure of the first application 133, or the failure score may be lower if the current value is less than the threshold).

In some implementations, the server 102 may train the recovery model 122 to generate one or recommended recovery actions (referred to herein as “recovery actions 178”) based on outputs of the anomaly detection models 152, output of the failure engine 120 (e.g., the indicators 172, the failure scores 174, and/or the reasons 176), or a combination thereof, and based on historical application recovery data. The historical application recovery data may include or indicate actions that were performed in response to application failures in the past. For example, the historical recovery data may include or be based on repair ticket data generated by system engineers during previous recovery and repair operations for the enterprise system 130 (e.g., for the first application 133, the second application 136, and the Nth application 139). Examples of recovery actions include rebooting applications, isolating applications that have failed or otherwise are associated with an anomaly, shutting down applications that are producing unexpected data, reconfiguring the enterprise system 130 to replace an application with a backup application, rescheduling one or more jobs, other actions, or the like. The recovery actions 178 that are output by the recovery model 122 may be recommended to prevent or mitigate a predicted application failure, to recover from a detected anomaly, to prevent or reduce cascading of additional application failures, or a combination thereof. As anon-limiting example, if the failure engine 120 outputs a predicted failure for the second application 136 based on a detected anomaly associated with the first application 133, the recovery model 122 may output, as the recovery actions 178, a recommendation to isolate the first application 133 for anti-malware scanning, a recommendation to reboot the second application 136 and to reconfigure the second application 136 to receive input data from another application instead of the first application 133, and a recommendation to monitor that one or more KPIs for the second application 136 satisfy enhanced thresholds. Such recommendations may include operations performed in part or in whole by the server 102, actions performed by a user of the user device 154, or both. In some implementations, one or more of the recovery actions 178 may be automatically performed or initiated by the server 102. The automatic performance may be preconfigured, based on one or more criteria, or the like. In the above described example, the server 102 may automatically reboot the second application 136 based on a failure score associated with the failure prediction for the second application 136 satisfying a score threshold. If the failure score fails to satisfy the score threshold, the server 102 may provide the recommendation to the user for the user to decide whether to initiate the recommended recover action.

After generating the application dependency graph 118 and training the anomaly detection models 152, the failure engine 120, and the recovery model 122, the server 102 may monitor performance of the enterprise system 130 to predict application failures. To illustrate, during operation of the enterprise system 130 corresponding to execution of the first application 133 by the first device 132, execution of the second application 136 by the second device 134, execution of the Nth application 139 by the Nth device 138, or a combination thereof, log data 161 may be generated and ingested by the server 102 and the model repository 150. The model repository 150 may provide the log data 161 as input to the anomaly detection models 152 to cause the anomaly detection models 152 to generate anomaly data 180 that indicates one or more detected anomalies corresponding to one or more applications. The server 102 may provide the anomaly data 180, and optionally the log data 161, as input data to the failure engine 120 to cause the failure engine 120 to output the indicators 172 (e.g., one or more indicators of applications that are predicted to fail), the reasons 176 (e.g., one or more reasons for predicted application failures), the failure scores 174 (e.g., one or more failure scores corresponding to reasons for failure associated with the predicted application failures, one or more failure scores corresponding to the predicted application failures, or a combination thereof), or a combination thereof. The server 102 may also provide the anomaly data 180, and optionally the log data 161, to the recovery model 122 to cause the recovery model 122 to output the recovery actions 178 (e.g., one or more recovery action recommendations).

To enable user(s) to monitor and manage the performance of the enterprise system 130, the server 102 may generate a dashboard 170 (e.g., a graphical user interface (GUI) or other user interface (UI)) that includes some or more of the information generated by the server 102 during the operations described herein. For example, the dashboard 170 may include (e.g., display or provide visualization of) the indicators 172 of the predicted application failures, the failure scores 174, the reasons 176, the recovery actions 178, other information, or a combination thereof. For example, the dashboard 170 may include a first region that displays the indicators 172 and the failure scores 174, a second region that displays the recovery actions 178 (and optionally selectable indicators to enable performance of the recovery actions 178), and a third region that displays additional information for a selected application failure prediction (e.g., a corresponding one of the reasons 176). In other implementations, the dashboard 170 may be configured in other manners to provide the indicators 172, the failure scores 174, the reasons 176, and the recovery actions 178. The server 102 may provide the dashboard 170 to the user device 154 for displaying to a user. Additionally or alternatively, the server 102 may include or be coupled to a display device that displays the dashboard 170. In some implementations, the dashboard 170 may include one or more user-interactive elements that enable the user to participate in the management of the enterprise system 130 and the recovery from predicted application failures. For example, the dashboard 170 may include one or more options that enable the user to verify that one or more of the applications for which a failure is predicted (e.g., corresponding to the indicators 172) is correct and not a false positive. As another example, the dashboard 170 may include one or more options that enable a user to initiate performance of actions to recover from a predicted application failure, such as one or more selectable options to initiate the recovery actions 178. Additionally or alternatively, the dashboard 170 may include other information, such as current KPI values monitored by the server 102 based on the log data 161, aggregated KPI or temporal information, other information, or a combination thereof.

As described above, the system 100 supports machine learning-based application management for enterprise systems. The techniques described with reference to FIG. 1 provide for improved scheduling of training of ML models that results in faster training, thereby enabling more frequent updating and accordingly better adaptation to changes in application data over time. To illustrate, the time-series data 110 (and the temporal components 112) generated based on the historical log data 160 may be used by the server 102 to perform clustering and assign applications (e.g., the first application 133, the second application 136, and the Nth application 139) into the training groups 114, and the server 102 may generate the training schedule 162 for the anomaly detection models 152 to take advantage of similarities in data processing between different groups of the training groups 114 and sequencing of models from interdependent groups. For example, anomaly detection models from the training groups 114 that are associated with the same preprocessing and/or post-processing operations may be scheduled to be trained concurrently according to the sequence 164 in order to perform the preprocessing and/or post-processing operations fewer times (e.g., together as a group), which may be more efficient than repeatedly performing the same preprocessing and post-processing operations with different anomaly detection models in a sequence. As another example, applications that are associated with one type of the temporal components 112, such as seasonal components, trend components, or cyclic components, may be identified as being dependent on applications associated with other types of the temporal components 112, and the sequence 164 may include sequential training of these anomaly detection models for the most efficient use of time and computational resources during the training. Thus, the training schedule 162 generated by the server 102 may result in faster and more resource-efficient training of the anomaly detection models 152, in some implementations reducing a multi-day or multi-week training time to a multi-hour training time, thereby improving operation of the system 100 (e.g., an application management system that trains ML models to perform anomaly detection). Additionally or alternatively, the system 100 may integrate the application dependency graph 118 with the anomaly detection models 152 as part of an overall application management service provided by the server 102 to predict application failures before they occur and provide reasoning and recommended recovery actions. To illustrate, by integrating the application dependency graph 118 with the anomaly detection models 152, the server 102 may predict application failures (e.g., corresponding to the indicators 172) with an approximately 30-40% reduction in false positives compared to rule-based anomaly detection systems. This improved training efficiency and reduction in false positives of failure prediction are achieved by the system 100 without requiring changes to the code of the underlying applications and microservices of the enterprise system (e.g., the first application 133, the second application 136, and the Nth application 139), instead the system 100 uses the historical log data 160 as a basis for application management operations. As such, the system 100 scales a single application anomaly detection system to a multi-application, enterprise-level system based on a historical data reference (e.g., the historical log data 160) that operates faster, and therefore is able to be updated more frequently to adapt to changes in application performance, and with fewer false positives than rule-based systems. The improved speed enables faster root cause analysis during application failure, faster team assignments, and better recommendations to reduce the resolution time. In some implementations, the system also provides automatic generation of the recovery actions 178 to recover, or mitigate or prevent, predicted application failures, thereby reducing downtime and associated costs to the enterprise system 130 as compared to conventional systems that focus on reactive actions and post-event analysis for system performance.

Referring to FIG. 2, a process flow of an example of a process for machine learning-based application management according to one or more aspects is shown as a process 200. In some implementations, operations described with reference to the process 200 may be performed by one or more components of the system 100 of FIG. 1.

The process 200 includes initiating self-organizing training jobs, at 202. The training jobs may be scheduled based on historical application data 230 from an enterprise system that executes a plurality of applications, such as the enterprise system 130 of FIG. 1. The historical application data 230 may include logs 232 (e.g., log data), application IDs 234 that identify the application from which the corresponding ones of the logs 232 were generated, and KPIs 236 derived from the logs 232. For example, the applications may generate the logs 232, and data such as the application IDs 234, application names, and the KPIs 236 (e.g., numbers of hits, success status counts, failure status counts, response time, etc.) may be extracted from the logs 232 to generate an analytical base table of time-series data for use in clustering, anomaly detection, and generation of an application dependency graph.

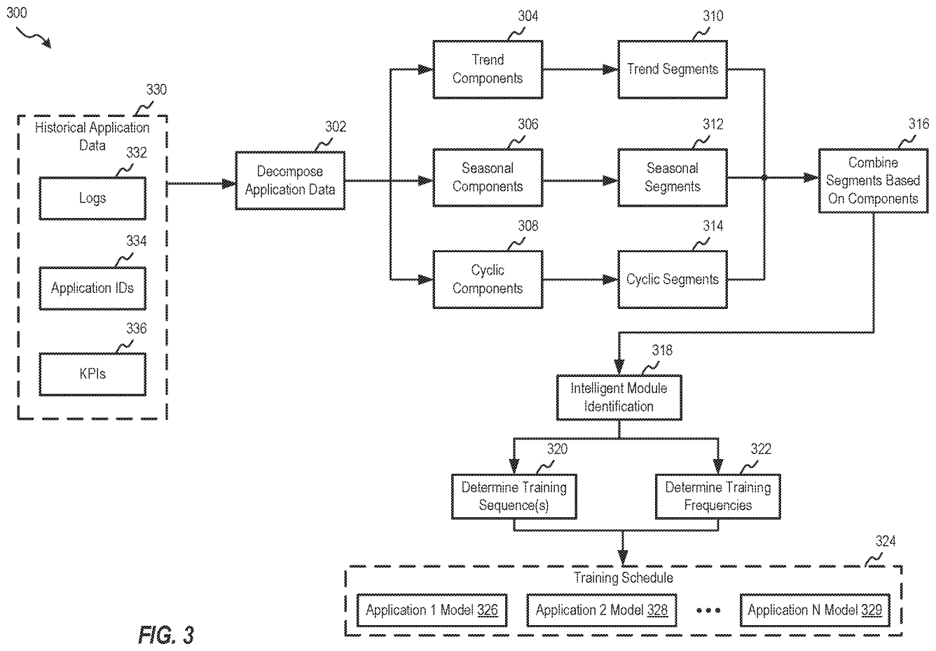

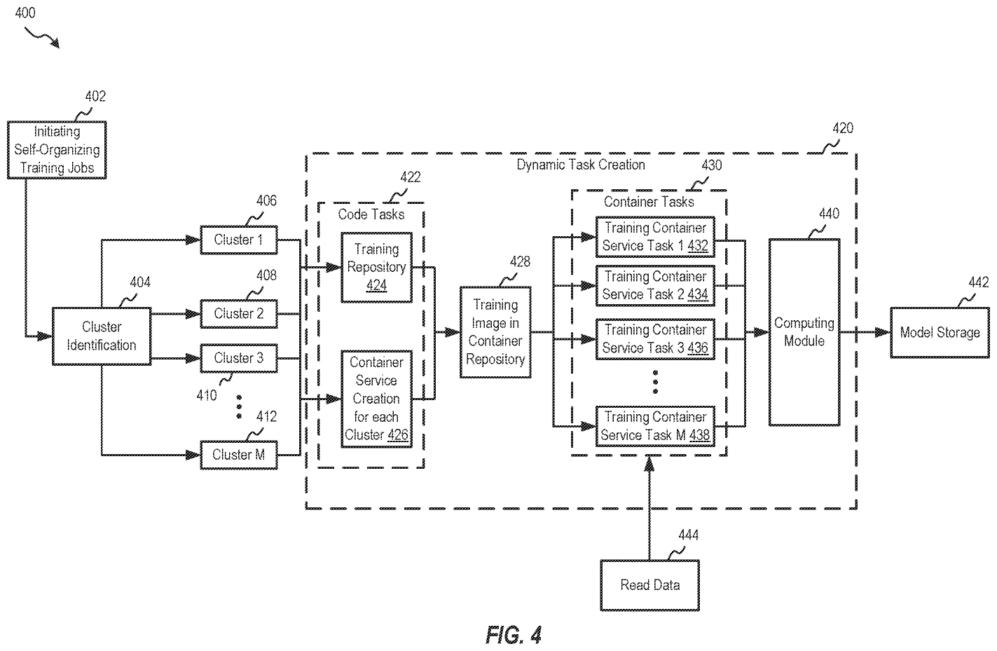

The training jobs are referred to as “self-organizing” because the historical application data 230 is used to generate time-series data from which temporal components may be derived that can be used to identify similar applications based on historical temporal components. Such similar applications may be scheduled for training based on these historical patterns. For example, clustering operations may be performed on the time-series data and the temporal components to assign the applications into multiple training groups, as described above with reference to FIG. 1. After the applications are assigned into groups, the groups may be scheduled for training according to a determined training schedule that reduces overall training time and resource use based on the groups, such as described with reference to FIG. 1 for the training schedule 162. For example, the training may include training a first group of anomaly detection models as a first set of training jobs 204 (“Training Jobs 1”), training a second group of anomaly detection models as a second set of training jobs 206 (“Training Jobs 2”), and training an Mth group of anomaly detection models as an Mth set of training jobs 208 (“Training Jobs M”). Additional details of the assigning of applications to groups and scheduling of the training are described further herein with reference to FIGS. 3 and 4.

The training jobs result in training of multiple anomaly detection models that each detect whether an anomaly has occurred with respect to a corresponding application. In some implementations, the anomaly detection models may be trained to check sparsity within the time-series data and use the central tendency for one of multiple different intervals for thresholding and prioritized detection of anomalies. The anomaly detection models may be saved and used in an inference pipeline. After training the anomaly detection models, the process 200 includes storing the trained anomaly detection models, at 210. For example, the multiple trained anomaly detection models may be saved and used in a single inference job to create a single endpoint. The process 200 includes performing anomaly inference generation, at 212. For example, the anomaly detection models may be fed current log data generated by the enterprise system (e.g., the applications or microservices underlying the enterprise system) to output detected anomalies for the applications. To further illustrate, multiple anomaly detection models may be stored in storage, and then the anomaly detection models may be stored in a data frame in the inference pipeline. Concatenation of the multiple anomaly detection models into a single container may act as a single endpoint. A single application programming interface (API) at the endpoint may be created for use with integration of an application dependency graph, as described below.

The process 200 includes generating an application dependency graph, at 214. In some implementations, the application dependency graph includes or corresponds to the application dependency graph 118 of FIG. 1. The application dependency graph may be generated based on the historical application data 230, and the application dependency graph may indicate dependencies between applications with respect to KPIs. For example, the application dependency graph may include nodes that correspond to applications, and the nodes may be linked by edges that correspond to KPIs for which there is a dependency between the applications that correspond to the linked nodes. In some implementations, data values may be aggregated daily, and the KPIs mapped to the edges include number of hits, response time, number of success hits, and success rate. In such implementations, the edge KPIs may be aggregated by source application for node classification, and the aggregation may include determining an average of the number of hits, determining a maximum of the response time, and determining a minimum of the success rate. Nodes may be classified as having a normal value, near anomaly, or anomaly based on the aggregated KPIs for the corresponding application. The process 200 includes appending output and integrating the application dependency graph, at 216. For example, the application dependency graph may be integrated with the anomaly inference pipeline formed from the multiple anomaly detection models. Integrating the application dependency graph with the anomaly detection models may include summarizing the output of the anomaly inference pipeline, including mean, median, central dispersion, and checking a severity of anomaly alert, and if there is a change from a previous period, updating the node data of the application dependency graph.

The process 200 includes identifying applications predicted to fail, at 218. For example, a failure engine may be trained to predict additional applications that will fail based on detected anomalies for one or more applications provided as input data. The training may be based on the application dependency graph. In some implementations, the failure engine, which may include or correspond to the failure engine 120 of FIG. 1, may integrate or access a graph convolutional network to identify which applications will fail over time. Additionally or alternatively, an autoencoder may be trained to identify clusters of applications which have risks using cluster graph risk identifier, and the cluster of applications are scored based on the risk. The process 200 includes determining reasons for the predicted application failures, at 220. For example, the failure engine may also be trained to output reasons for predicted application failures, thereby identifying for a user why a particular application has failed or is predicted to fail. In some implementations, various features may be identified at the nodes of the application dependency graph, in addition to effects of neighboring applications and KPIs such as response time, success rate, and anomaly detection flags. The failure engine may include a reasoning engine that creates a probability table which identifies the causality between events, and each relation may provide the score of failure. The process 200 includes performing model-based application recovery, at 222. For example, an application recovery model may be trained based on historical recovery operation data, such as ticket data, to output one or more recovery action recommendations based on detected anomalies and/or predicted application failures. In some implementations, the application recovery model may include or correspond to the recovery model 122 of FIG. 1. Performing the model-based application recovery may include identifying application failures and reasons for the failures, mapping the failures with the potential recovery actions, training states of the application recovery model and actions using a deep q network, and once trained, getting recommendations for recovery actions from the model.

Referring to FIG. 3, a process flow of an example of a process for scheduling training of anomaly detection models based on historical application data according to one or more aspects is shown as a process 300. Operations described with reference to the process 300 may be performed as part of one or more operations of the process 200 of FIG. 2. In some implementations, operations described with reference to the process 300 may be performed by one or more components of the system 100 of FIG. 1.

The process 300 includes decomposing application data, at 302. For example, historical application data 330 associated with an enterprise system that executes a plurality of applications may be decomposed to generate time-series data. The historical application data 330 may include logs 332 (e.g., log data), application IDs 334 that identify the application from which the corresponding ones of the logs 332 were generated, and KPIs 336 derived from the logs 332. The historical application data 330 may be processed to generate time-series data, as described above with reference to FIGS. 1 and 2.

After decomposing the historical application data 330 into time-series data, the time-series data may be used to derive (e.g., extract) one or more temporal components, such as trend components 304, seasonal components 306, and cyclic components 308. The trend components, the seasonal components, and the cyclic components may correspond to temporal aspects of the data, as described above with reference to FIG. 1. The time-series data may indicate the components, and corresponding portions of the time series data may be separated according to the components 304, 306, and 308. The components may then be segmented into random time-based segments to generate corresponding segments. For example, the trend components 304 may be transformed into trend segments 310, the seasonal components 306 may be transformed into seasonal segments 312, and the cyclic components 308 may be transformed into cyclic segments 314.

The process 300 includes combining the segments based on components, at 316. For example, some or all possible combinations of trend, seasonality, and cyclic segments may be combined to form the combined segments. The process 300 includes providing the combinations of segments to an intelligent module for identification training groups for assigning the corresponding applications, at 318. For example, the combination that provides for an optimized use of time and computing resources during training may be identified, and the combination is used for determining a training schedule. The intelligent module may assign the time when training jobs will run based on at least some of the temporal components, such as seasonality components and cyclic components, in some examples. To illustrate, the process 300 includes determining one or more training sequences for anomaly detection models that correspond to the grouped applications, at 320. For example, the training sequences may include or correspond to the sequence 164 and the sequences 166 of FIG. 1. The process 300 also includes determining training frequencies for anomaly detection models that correspond to the grouped applications, at 322. For example, the training frequencies may include or correspond to the training frequencies 116 of FIG. 1. The process 300 includes generating a training schedule 324 for training of anomaly detection models. For example, the training schedule 324 may include or correspond to the training schedule 162 of FIG. 1. The training schedule 324 may indicate timing and frequency of training for anomaly detection models corresponding to each of the applications, such as a first anomaly detection model 326 (“Application 1 Model”), a second anomaly detection model 328 (“Application 2 Model”), and an Nth anomaly detection model 329 (“Application N Model”). The training order of the anomaly detection models, and the timing of additional training/updating, may be based on the training sequences determined at 320 and the training frequencies determined at 322.

Referring to FIG. 4, a process flow of an example of a process for training a plurality of anomaly detection models for enterprise system applications according to one or more aspects is shown as a process 400. In some implementations, operations described with reference to the process 400 may be performed by one or more components of the system 100 of FIG. 1.

The process 400 includes initiating self-organizing training jobs, at 402. Initiating the self-organizing training jobs may include decomposing historical application data into time-series data and deriving temporal components from the time-series data, as described above with reference to FIGS. 1-3. The process 400 includes identifying and assigning applications to clusters, at 404. For example, one or more clustering operations may be performed on the temporal components derived from the time-series data to assign each of the applications to one of a first cluster 406 (“Cluster 1”), a second cluster 408 (“Cluster 2”), a third cluster 410 (“Cluster 3”), or an Mth cluster 412 (“Cluster M”).

After the applications are clustered and assigned to the training groups (e.g., clusters), the clusters may be provided for dynamic task creation of anomaly detection models, at 420. In some implementations, the dynamic task creation may be performed by a cloud-based ML training service. As initial operations, code for training anomaly detection models may be pulled from a training repository, at 424, and container services for each cluster may be created, at 426. In some implementations, the cloud service triggers a code pipeline that includes the training repository with every new code commit. The code pipeline may be responsible for creating Docker images, image tagging, and pushing images to the container repository. The container services may be created by execution of a Python script that reads the cluster output to create container resources per cluster such as container services task definition, deregistering existing container services task, and scheduling container services task by rule input by self-organizing training jobs. As a result, a training image for each of the anomaly detection models, grouped by the clusters, may be created in a container repository, at 428.

The training images may be used to initiate training container service tasks to train the anomaly detection models, at 430. For example, a scheduler may execute the code pipeline at a certain time, such as according to a training schedule such as the training schedule 162 of FIG. 1. Each training container service task may be used to train anomaly detection models for the applications of a corresponding cluster. For example, the training container service tasks may include a first training service task 432 (“Training Container Service Task 1”) that corresponds to the first cluster 406, a second training service task 434 (“Training Container Service Task 2”) that corresponds to the second cluster 408, a third training service task 436 (“Training Container Service Task 3”) that corresponds to the third cluster 410, and an Mth training service task 438 (“Training Container Service Task M”) that corresponds to the Mth cluster 412. The training may be performed based on read data 444. Training of the anomaly detection models may proceed from the container tasks to a computing module, at 440. After training the anomaly detection models, process 400 includes storing the trained anomaly detection models in model storage, at 442. For example, model artifacts for the applications may be written to storage after anomaly training jobs have been successfully completed and saved in storage.

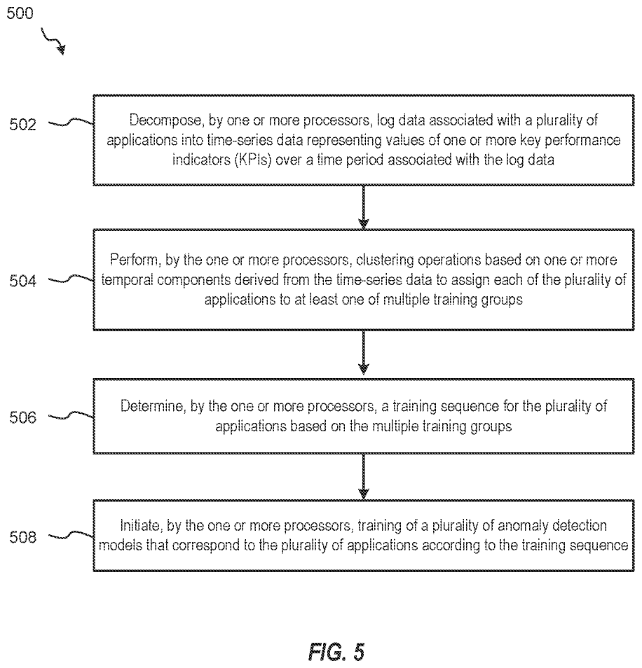

Referring to FIG. 5, a flow diagram of an example of a method for machine learning-based application management according to one or more aspects is shown as a method 500. In some implementations, the operations of the method 500 may be stored as instructions that, when executed by one or more processors (e.g., the one or more processors of a computing device or a server), cause the one or more processors to perform the operations of the method 500. In some implementations, these instructions may be stored on a non-transitory computer-readable storage medium. In some implementations, the method 500 may be performed by a computing device, such as the server 102 of FIG. 1 (e.g., a device configured for machine learning-based application management), the model repository 150 of FIG. 1, the user device 154 of FIG. 1, one or more of devices 132, 134, and 138 of FIG. 1, or a combination thereof.

The method 500 includes decomposing log data associated with a plurality of applications into time-series data representing values of one or more KPIs over a time period associated with the log data, at 502. For example, the log data may include or correspond to the historical log data 160 of FIG. 1 and the time-series data may include or correspond to the time-series data 110 of FIG. 1. The method 500 includes performing clustering operations based on one or more temporal components derived from the time-series data to assign each of the plurality of applications to at least one of multiple training groups, at 504. For example, the one or more temporal components may include or correspond to the temporal components 112 of FIG. 1, and the multiple training groups may include or correspond to the training groups 114. In some implementations, the one or more temporal components include trend components, seasonal components, cyclic components, or a combination thereof. For example, the trend components may include or correspond to the trend components 304 of FIG. 3, the seasonal components may include or correspond to the seasonal components 306 of FIG. 3, and the cyclic components 308 may include or correspond to the cyclic components 308 of FIG. 3.

The method 500 includes determining a training sequence for the plurality of applications based on the multiple training groups, at 506. For example, the training sequence may include or correspond to the sequence 164 of FIG. 1. The method 500 includes initiating training of a plurality of anomaly detection models that correspond to the plurality of applications according to the training sequence, at 508. Each anomaly detection model of the plurality of anomaly detection models includes or corresponds to a ML model configured to detect occurrence of an anomaly by a corresponding application based on received application data. For example, the plurality of anomaly detection models may include or correspond to the anomaly detection models 152 of FIG. 1.

In some implementations, the method 500 may also include determining training frequencies for the plurality of anomaly detection models based on the time-series data and generating a training schedule for the plurality of anomaly detection models based on the training frequencies and the training sequence. The training schedule includes the training sequence and one or more future training sequences. For example, the training frequencies may include or correspond to the training frequencies 116 of FIG. 1, the training schedule may include or correspond to the training schedule 162 of FIG. 1, and the one or more future training sequences may include or correspond to the sequences 166 of FIG. 1.

In some implementations, the training of the plurality of anomaly detection models according to the training sequence includes concurrently training one or more anomaly detection models of a first training group of the multiple training groups and one or more anomaly detection models of a second training group of the multiple training groups. In some such implementations, training an anomaly detection model of the first training group may include performing one or more same preprocessing operations, one or more same post-processing operations, or a combination thereof, than training an anomaly detection model of the second training group. Additionally, or alternatively, the training of the plurality of anomaly detection models according to the training sequence may include training a first anomaly detection model of a first training group of the multiple training groups and a second anomaly detection model of the first training group in series. In some such implementations, training the first anomaly detection model may include performing one or more different preprocessing operations, one or more different post-processing operations, or a combination thereof, as training the second anomaly detection model.

In some implementations, the method 500 also includes generating an application dependency graph based on the time-series data, the log data, or a combination thereof, and initiating training of a failure engine based on the application dependency graph to output indicators of applications that are predicted to fail. The failure engine may execute a ML model configured to identify one or more additional applications that are predicted to fail based on one or more detected anomalies output by the plurality of anomaly detection models. For example, the application dependency graph may include or correspond to the application dependency graph 118 of FIG. 1, the failure engine may include or correspond to the failure engine 120 of FIG. 1, and the indicators of applications that are predicted to fail may include or correspond to the indicators 172 of FIG. 1. In some such implementations, the failure engine is further trained based on the application dependency graph to configure the failure engine to output failure scores corresponding to reasons for failure associated with the applications that are predicted to fail. For example, the failure scores may include or correspond to the failure scores 174 of FIG. 1, and the reasons for failure may include or correspond to the reasons 176 of FIG. 1. In some such implementations, the method 500 further includes initiating training of an application recovery model based on historical recovery action data, the log data, and the application dependency graph. The application recovery model includes an ML model configured to output recovery actions based on input indicators of applications that are predicted to fail. For example, the application recovery model may include or correspond to the recovery model 122 of FIG. 1, and the recovery actions may include or correspond to the recovery actions 178 of FIG. 1.

In some implementations that include training the application recovery model, the method 500 also includes providing current log data as input data to the plurality of anomaly detection models to generate one or more detected anomalies associated with one or more applications of the plurality of applications, providing the one or more detected anomalies as input data to the failure engine to generate one or more indicators of applications that are predicted to fail and one or more failure scores corresponding to reasons for failure associated with the applications that are predicted to fail, providing the one or more indicators of the applications that are predicted to fail as input data to the application recovery model to generate one or more recovery action recommendations, and displaying a dashboard that indicates the applications that are predicted to fail, the one or more failure scores, the reasons for failure, the one or more recovery action recommendations, or a combination thereof. For example, the current log data may include or correspond to the log data 161 of FIG. 1, the one or more detected anomalies may include or correspond to the anomaly data 180, and the dashboard may include or correspond to the dashboard 170 of FIG. 1. In some such implementations, the method 500 further includes initiating automatic performance of an action indicated by the one or more recovery action recommendations. For example, the server 102 of FIG. 1 may initiate automatic performance of one or more of the recovery actions 178. The action (e.g., the recovery action) may include re-executing one or more of the applications that are predicted to fail, terminating one or more of the applications that are predicted to fail, or a combination thereof.

It is noted that other types of devices and functionality may be provided according to aspects of the present disclosure and discussion of specific devices and functionality herein have been provided for purposes of illustration, rather than by way of limitation. It is noted that the operations of the process 200 of FIG. 2, the process 300 of FIG. 3, the process 400 of FIG. 4, and the method 500 of FIG. 5 may be performed in any order. Additionally or alternatively, one or more operations described with reference to the process 200 of FIG. 2, the process 300 of FIG. 3, the process 400 of FIG. 4, or the method 500 may be performed during performance of another of the process 200 of FIG. 2, the process 300 of FIG. 3, the process 400 of FIG. 4, or the method 500. It is also noted that the method 500 of FIG. 5 may also include other functionality or operations consistent with the description of the operations of the system 100 of FIG. 1.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-5) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for machine learning-based application management, the method comprising:
decomposing, by one or more processors, log data associated with a plurality of applications into time-series data representing values of one or more key performance indicators (KPIs) over a time period associated with the log data;
performing, by the one or more processors, clustering operations based on one or more temporal components derived from the time-series data to assign each of the plurality of applications to at least one of multiple training groups;
determining, by the one or more processors, a training sequence for the plurality of applications based on the multiple training groups; and
initiating, by the one or more processors, training of a plurality of anomaly detection models that correspond to the plurality of applications according to the training sequence,
wherein each anomaly detection model of the plurality of anomaly detection models comprises a machine learning (ML) model configured to detect occurrence of an anomaly by a corresponding application based on received application data.

2. The method of claim 1, wherein the one or more temporal components comprise trend components, seasonal components, cyclic components, or a combination thereof.

3. The method of claim 1, further comprising:
determining, by the one or more processors, training frequencies for the plurality of anomaly detection models based on the time-series data; and
generating, by the one or more processors, a training schedule for the plurality of anomaly detection models based on the training frequencies and the training sequence, the training schedule including the training sequence and one or more future training sequences.

4. The method of claim 1, wherein the training of the plurality of anomaly detection models according to the training sequence includes concurrently training one or more anomaly detection models of a first training group of the multiple training groups and one or more anomaly detection models of a second training group of the multiple training groups.

5. The method of claim 4, wherein training an anomaly detection model of the first training group comprises performing one or more same preprocessing operations, one or more same post-processing operations, or a combination thereof, than training an anomaly detection model of the second training group.

6. The method of claim 1, wherein the training of the plurality of anomaly detection models according to the training sequence includes training a first anomaly detection model of a first training group of the multiple training groups and a second anomaly detection model of the first training group in series.

7. The method of claim 6, wherein training the first anomaly detection model comprises performing one or more different preprocessing operations, one or more different post-processing operations, or a combination thereof, as training the second anomaly detection model.

8. The method of claim 1, further comprising:
generating, by the one or more processors, an application dependency graph based on the time-series data, the log data, or a combination thereof; and
initiating, by the one or more processors, training of a failure engine based on the application dependency graph to output indicators of applications that are predicted to fail,
wherein the failure engine executes a ML model configured to identify one or more additional applications that are predicted to fail based on one or more detected anomalies output by the plurality of anomaly detection models.

9. The method of claim 8, wherein the failure engine is further trained based on the application dependency graph to configure the failure engine to output failure scores corresponding to reasons for failure associated with the applications that are predicted to fail.

10. The method of claim 9, further comprising:
initiating, by the one or more processors, training of an application recovery model based on historical recovery action data, the log data, and the application dependency graph,
wherein the application recovery model comprises an ML model configured to output recovery actions based on input indicators of applications that are predicted to fail.

11. The method of claim 10, further comprising:
providing, by the one or more processors, current log data as input data to the plurality of anomaly detection models to generate one or more detected anomalies associated with one or more applications of the plurality of applications;
providing, by the one or more processors, the one or more detected anomalies as input data to the failure engine to generate one or more indicators of applications that are predicted to fail and one or more failure scores corresponding to reasons for failure associated with the applications that are predicted to fail;
providing, by the one or more processors, the one or more indicators of the applications that are predicted to fail as input data to the application recovery model to generate one or more recovery action recommendations; and
displaying, by the one or more processors, a dashboard that indicates the applications that are predicted to fail, the one or more failure scores, the reasons for failure, the one or more recovery action recommendations, or a combination thereof.

12. The method of claim 11, further comprising:
initiating, by the one or more processors, automatic performance of an action indicated by the one or more recovery action recommendations.

13. The method of claim 12, wherein the action comprises re-executing one or more of the applications that are predicted to fail, terminating one or more of the applications that are predicted to fail, or a combination thereof.

14. A system for machine learning-based application management, the system comprising:
a memory; and
one or more processors communicatively coupled to the memory, the one or more processors configured to:
decompose log data associated with a plurality of applications into time-series data representing values of one or more key performance indicators (KPIs) over a time period associated with the log data;
perform clustering operations based on one or more temporal components derived from the time-series data to assign each of the plurality of applications to at least one of multiple training groups;
determine a training sequence for the plurality of applications based on the multiple training groups; and
train a plurality of anomaly detection models that correspond to the plurality of applications according to the training sequence,
wherein each anomaly detection model of the plurality of anomaly detection models comprises a machine learning (ML) model configured to detect occurrence of an anomaly by a corresponding application based on received application data.

15. The system of claim 14, wherein the one or more processors are further configured to:
generate an application dependency graph based on the time-series data, the log data, or a combination thereof; and
initiate training of a failure engine based on the application dependency graph to output indicators of applications that are predicted to fail,
wherein the failure engine is configured to execute a ML model configured to identify one or more additional applications that are predicted to fail based on one or more detected anomalies output by the plurality of anomaly detection models.

16. The system of claim 15, wherein the failure engine is further trained based on the application dependency graph to configure the failure engine to output failure scores corresponding to reasons for failure associated with the applications that are predicted to fail.

17. The system of claim 16, wherein the one or more processors are further configured to:
initiate training of an application recovery model based on historical recovery action data, the log data, and the application dependency graph,
wherein the application recovery model comprises an ML model configured to output recovery actions based on input indicators of applications that are predicted to fail.

18. The system of claim 17, wherein the one or more processors are further configured to:
provide current log data as input data to the plurality of anomaly detection models to generate one or more detected anomalies associated with one or more applications of the plurality of applications;
provide the one or more detected anomalies as input data to the failure engine to generate one or more indicators of applications that are predicted to fail and one or more failure scores corresponding to reasons for failure associated with the applications that are predicted to fail;
provide the one or more indicators of the applications that are predicted to fail as input data to the application recovery model to generate one or more recovery action recommendations; and
display a dashboard that indicates the applications that are predicted to fail, the one or more failure scores, the one or more recovery action recommendations, or a combination thereof.

19. A non-transitory computer-readable storage medium storing instructions that, when executed by one or more processors, cause the one or more processors to perform operations for machine learning-based application management, the operations comprising:
decomposing log data associated with a plurality of applications into time-series data representing values of one or more key performance indicators (KPIs) over a time period associated with the log data;
performing clustering operations based on one or more temporal components derived from the time-series data to assign each of the plurality of applications to at least one of multiple training groups;
determining a training sequence for the plurality of applications based on the multiple training groups; and
initiating, by the one or more processors, training of a plurality of anomaly detection models that correspond to the plurality of applications according to the training sequence,
wherein each anomaly detection model of the plurality of anomaly detection models comprises a machine learning (ML) model configured to detect occurrence of an anomaly by a corresponding application based on received application data.

20. The non-transitory computer-readable storage medium of claim 19, wherein the operations further comprise:
determining training frequencies for the plurality of anomaly detection models based on the time-series data; and
generating a training schedule for the plurality of anomaly detection models based on the training frequencies and the training sequence, the training schedule including the training sequence and one or more future training sequences.
